(19) United States
(12) Patent Application Publication
(10) Pub. No.: US 2025/0126085 A1
(43) Pub. Date: Apr. 17, 2025

(54) SYSTEM, METHOD, AND STORAGE MEDIUM FOR TRANSMITTING SMS MESSAGE USING API

(71) Applicant: SORACOM, INC., Tokyo (JP)

(72) Inventor: Kazuki NAKANISHI, Yokohama-shi (JP)

(21) Appl. No.: 19/002,029

(22) Filed: Dec. 26, 2024

Related U.S. Application Data
(63) Continuation of application No. PCT/JP2023/024940, filed on Jul. 5, 2023.

(30) Foreign Application Priority Data
Jul. 5, 2022 (JP) 2022-108130

(51) Int. Cl. H04L 51/21; H04W 4/14

(52) U.S. Cl. CPC H04L 51/21; H04W 4/14

(57) ABSTRACT

An API server receives an API call from a user terminal. The API server assigns a message ID to each destination determined by the call. The API server returns a success response to the user terminal in a case where a number of calls including a campaign ID has not reached an upper limit in comparison with a call threshold. Then, the API server adds, to a first queue connected thereto, a first message transmission request including one or more message IDs and an identifier of a user of the user terminal. A first control server which obtains it, performs flow rate control based on a first flow rate threshold for each identifier, generates a second message transmission request for each destination to add to a second queue, and a second control server connected thereto transmits an SMS message transmission requests.

### CROSS-REFERENCE TO RELATED APPLICATION(S)

This application is a continuation of International Patent Application No. PCT/JP2023/024940 filed on Jul. 5, 2023, which claims priority to and the benefit of Japanese Patent Application No. 2022-108130 filed on Jul. 5, 2022, the entire disclosures of which are incorporated herein by reference.

### BACKGROUND OF THE INVENTION

### Field of the Invention

The present invention relates to a system, method, and storage medium for transmitting a short message service (SMS) message using application programming interface (API) and particularly relates to a system, method, and storage medium for transmitting an SMS message using API via an SMS gateway that communicates with an SMS center (SMSC) of a mobile network operator (MNO).

### Description of the Related Art

SMS is a known service that transmits messages using a phone number. Messages sent via SMS (also referred to as “SMS messages”) can be exchanged between mobile phones as well as being exchanged using an SMS gateway service that provides an API for transmitting messages on an IP network. In response to the API call, the SMSC, a system of the MNO for transmitting SMS, and the system of the business operator providing the SMS gateway service communicate to transmit the message to the destination phone number via the MNO.

SMS messages are considered to have a high open rate and are used in various activities by companies focused on sales activities.

### SUMMARY OF THE INVENTION

When SMS is used in the activities of companies, often many messages with the same, similar, or related content will be transmitted for a specific purpose. However, the system of the SMS gateway service business operator has an upper limit to the number of messages that can be transmitted per unit time. Thus, for example, if a company tries to transmit a message to 10000 people and the upper limit is 30 messages per second, other companies cannot transmit for more than five minutes until the transmission ends, leading to unfairness between users. A similar problem may even occur between a plurality of users within the same company.

The present invention has been made in consideration of the aforementioned problems and realizes a system, and a method for transmitting SMS messages using API and a program therefor to suppress inequity among users.

In order to achieve such objectives, a first aspect of the present invention is a method for transmitting an SMS message using API via an SMS gateway that communicates with an SMSC of an MNO, the method comprising: receiving, by an API server, a first call of the API from a first user terminal; assigning, by the API server, a message ID to each one or plurality of destinations determined by the first call; adding, by the API server, to a first queue connected to the API server, a first message transmission request including at least a portion of assigned one or plurality of message IDs and a first identifier of a first user of the first user terminal or a first company they belong to; and in a case where a number of first message transmission requests including the first identifier received within a first time period has not reached a first upper limit in comparison with a first flow rate threshold (a positive number equal to or greater than 1), adding, by a first control server connected to the first queue, to a second queue connected to the first control server, a second message transmission request including each one of the at least a portion included in the first message transmission request, and in a case where the first upper limit has been reached, ceasing, by the first control server, to add the second message transmission request to the second queue until a first predetermined condition is satisfied, wherein a second control server connected to the second queue transmits, to the SMS gateway, an SMS message transmission request according to an IP protocol corresponding to the second message generation request.

A second aspect of the present invention is the method according to the first aspect, wherein the call includes one or more message bodies.

A third aspect of the present invention is the method according to the first aspect, further comprising: in a case where a number of calls of the API including a campaign ID determined by the first call received within a certain time period has not reached a call upper limit in comparison with a call threshold (a positive number equal to or greater than 1), adding, by the API server, the first message transmission request to the first queue; and responding, by the API server, to the first user terminal with an error response in a case where the call upper limit has been reached.

A fourth aspect of the present invention is the method according to the third aspect, wherein the first flow rate threshold is greater than the call threshold.

A fifth aspect of the present invention is the method according to the first aspect, wherein in a case where a number of second message generation requests received within a second time period has not reached a second upper limit in comparison with a second flow rate threshold (a positive number equal to or greater than 1), the second control server transmits the SMS message transmission request to the SMS gateway.

A sixth aspect of the present invention is the method according to the fifth aspect, wherein the second message transmission request includes a destination corresponding to a message ID included in the second message transmission request, and the second queue is selected by the first control server according to a destination included in the second message transmission request.

A seventh aspect of the present invention is the method according to the sixth aspect, wherein the first flow rate threshold is a value determined for the selected second queue, or the second control server or the SMS gateway associated therewith.

An eighth aspect of the present invention is the method according to the first aspect or 6, further comprising: receiving, by the API server, from a second user terminal, a second call of the API not including a valid campaign designation and including a single destination; assigning, by the API server, a single message ID to the second call; and adding, by the first control server, a second message transmission request including the single destination and the single message ID to a one-off queue connected to the second control server.

A ninth aspect of the present invention is the method according to the sixth aspect, wherein the second flow rate threshold is a value determined for the selected second queue, or the second control server or the SMS gateway associated therewith.

A tenth aspect of the present invention is the method according to the ninth aspect, wherein the first flow rate threshold is less than the second flow rate threshold.

An eleventh aspect of the present invention is a program for causing a system comprising an API server and a first control server to execute a method for transmitting an SMS message using API via an SMS gateway that communicates with an SMSC of an MNO, the method comprising: receiving, by an API server, a first call of the API from a first user terminal; assigning, by the API server, a message ID to each one or plurality of destinations determined by the first call; adding, by the API server, to a first queue connected to the API server, a first message transmission request including at least a portion of assigned one or plurality of message IDs and a first identifier of a first user of the first user terminal or a first company they belong to; and in a case where a number of first message transmission requests including the first identifier received within a first time period has not reached a first upper limit in comparison with a first flow rate threshold (a positive number equal to or greater than 1), adding, by a first control server connected to the first queue, to a second queue connected to the first control server, a second message transmission request including each one of the at least a portion included in the first message transmission request, and in a case where the first upper limit has been reached, ceasing, by the first control server, to add the second message transmission request to the second queue until a first predetermined condition is satisfied, wherein a second control server connected to the second queue transmits, to the SMS gateway, an SMS message transmission request according to an IP protocol corresponding to the second message generation request.

A twelfth aspect of the present invention is a system comprising a first control server and an API server for transmitting an SMS message using API via an SMS gateway that communicates with an SMSC of an MNO, wherein the API server receives a first call of the API from a first user terminal, assigns a message ID to each one or plurality of destinations determined by the first call, adds, to a first queue connected to the API server, a first message transmission request including at least a portion of assigned one or plurality of message IDs and a first identifier of a first user of the first user terminal or a first company they belong to, and the first control server connected to the first queue in a case where a number of first message transmission requests including the first identifier received within a first time period has not reached a first upper limit in comparison with a first flow rate threshold (a positive number equal to or greater than 1), adds, to a second queue connected to the first control server, a second message transmission request including each one of the at least a portion included in the first message transmission request, and in a case where the first upper limit has been reached, ceases to add the second message transmission request to the second queue until a first predetermined condition is satisfied, wherein a second control server connected to the second queue transmits, to the SMS gateway, an SMS message transmission request according to an IP protocol corresponding to the second message generation request.

According to an aspect of the present invention, to transmit SMS messages via an SMS gateway that communicates with an SMSC of an MNO using an API, an API server assigns a message ID to each one or plurality of destinations determined by a call of the API received from a user terminal; and adds, to a first queue connected to the API server, a first message transmission request including at least a portion of assigned one or plurality of message IDs and an identifier of a user of the user terminal or a company they belong to. A first control server connected to the first queue performs flow rate control per identifier to achieve fairness for the amount of time required to transmit SMS messages.

Further features of the present invention will become apparent from the following description of exemplary embodiments with reference to the attached drawings.

### BRIEF DESCRIPTION OF THE DRAWINGS

FIG. 1 is a diagram illustrating a system for transmitting SMS messages using an API according to an embodiment of the present invention.

FIG. 2 is a diagram illustrating the flow of a method for transmitting SMS messages using an API according to an embodiment of the present invention.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

Embodiments of the present invention will be described in detail below with reference to the drawings.

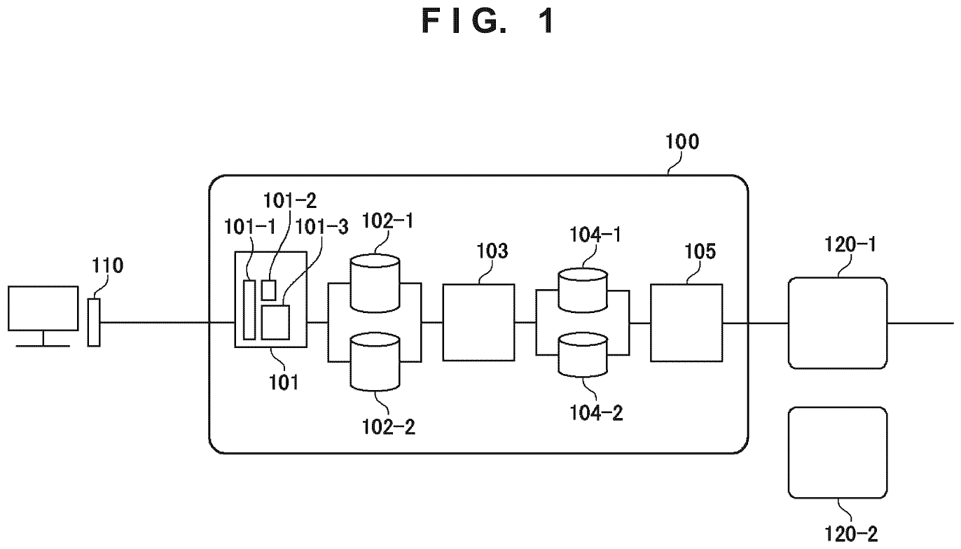

FIG. 1 illustrates a system according to an embodiment of the present invention. A system 100 is a system for transmitting SMS messages using API. The system 100 receives an API call from a user terminal 110 used by a user to transmit an SMS message and transmits an SMS message transmission request to an SMS gateway 120-1.

Here, the SMS gateway 120-1 is a system that communicates with the system 100 using an IP protocol and communicates with the SMSC (not illustrated) of the MNO using an SMPP protocol, a mobile application part (MAP) protocol, or the like. Specifically, for example, the SMS gateway 120-1 includes a short message peer-to-peer (SMPP) server connected to the SMSC and an SMPP client that communicates with the SMPP server, and the system 100 sends a message transmission request to the SMPP client. The SMPP client may conceivably be included as a part of the system 100, but in the present specification, the system 100 is mainly described using an example in which the SMPP client is not included. Also, a plurality of SMS gateways may exist as described below, and any one of these may be selected as the transmission destination of the message transmission request. In FIG. 1, in addition to the first SMS gateway 120-1, a second SMS gateway 120-2 is also illustrated. Hereinafter, for clarity, the first SMS gateway 120-1 will simply be referred to as the “SMS gateway 120”.

The system 100 may include an API server 101 that receives an API call and assigns a message ID to each one or a plurality of destinations included in the call, a first control server 103 that receives a first message transmission request generated by the API server 101 and added to a first queue 102-1 and selects the SMS gateway 120 for each destination included in the first message transmission request as necessary, and a second control server 105 that receives a second message transmission request generated by the first control server 103 and added to a second queue 104-1 for each message ID and transmits a transmission request according to an IP protocol that supports the second message transmission request to the SMS gateway 120.

There are cases where an API call includes and does not include a campaign ID for identifying a “campaign” in which a message with the same, similar, or related content is transmitted to a plurality of destinations for a specific purpose. As described below, in a case where it is not included, a request may be added to a first one-off queue 102-2 and a second one-off queue 104-2.

The API server 101 includes a communication unit 101-1 such as a communication interface; a processing unit 101-2 such as a processor, CPU, or the like; and a storage unit 101-3 such as a storage apparatus or storage medium including a memory, a hard disk, or the like and can be configured by executing a program for executing each process. The API server 101 may include one or more servers. Also, the program may include one or more programs or may be a non-transitory program product stored on a computer-readable storage medium. The program may be stored in the storage unit 101-3 or a storage apparatus or storage medium such as a database or the like that can be accessed from the API server 101 from an IP network and may be executed at the processing unit 101-2. Hereinafter, the data described as being stored in the storage unit 101-3 may be stored in the database and vice versa.

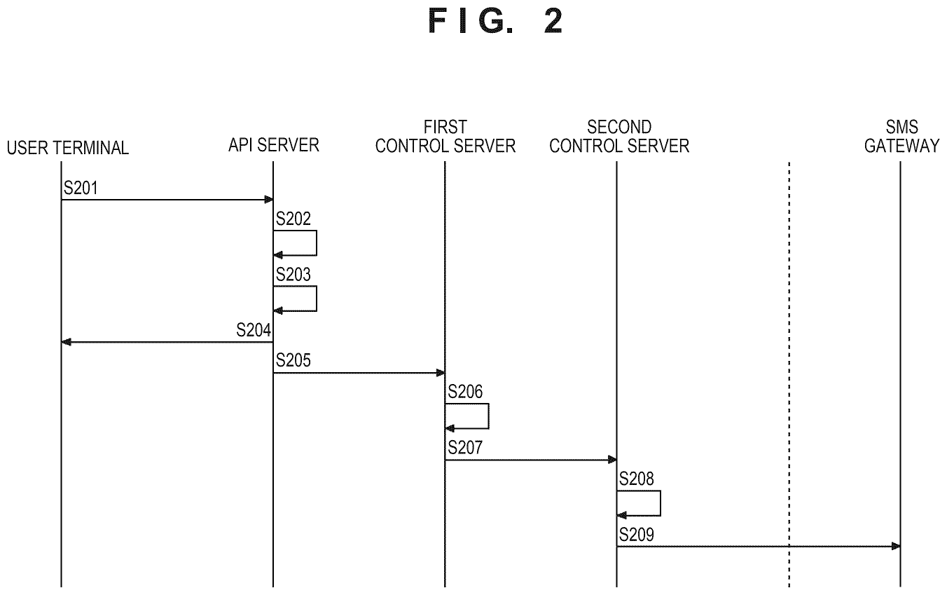

FIG. 2 illustrates the flow of a method of providing an API for transmitting SMS messages according to an embodiment of the present invention. First, the API server 101 receives a call of the API provided by the API server 101 from the user terminal 110 (S201). The API server 101 that receives the call assigns a message ID to each one or a plurality of destinations determined by the call and stores this in the storage unit 101-3 associated with the corresponding destination (S202).

The call may include one or more destinations, one or more message bodies, an identifier of a user or a company they belong to or authentication information associated therewith, and a campaign ID. In a case where a plurality of destinations for transmitting messages in a campaign identified by a campaign ID is associated with the campaign ID and stored in the API server 101, the API server 101 can identify the destinations on the basis of the campaign ID included in the call even if the destinations are not included in the call. In a case where the message body is not the same for each destination, a message body is prepared for each destination.

For example, the API call can be described as follows. In this example, the endpoint is different for each campaign ID represented by campaignId. POST https://api.soracom.io/v1/sms_a2p/campaigns/{campaignId}/send_sms

{
“to”: [“+819011111111”, “+819022222222”, (abbreviated)],
“payload”: “Your authentication code is 1234”,
“encoding”: “ucs2”,
“callback”: “https://callback-domain/sms_result”
}

In a case where the campaign ID is included in the call, the API server 101 stores the association of one or more campaign IDs and the number of calls including each campaign ID received within a certain time period in the storage unit 101-3 and, each time a new call is received, updates via incrementing the number of calls corresponding to the campaign ID included in the call (S203). When the number of calls corresponding to the campaign ID included in a new call is equal to or less than a call threshold (a positive number equal to or greater than 1), the API server 101 may respond to the user terminal 110 with a success response. When it is equal to or greater than the call threshold, the API server 101 may respond to the user terminal 110 with an error response. More generally, in a case where the number of calls including the campaign ID determined by a new call is compared with a call threshold and the call upper limit has been reached, the API server 101 may not receive the call and may respond to the user terminal 110 with an error response. In a case where the call upper limit has not been reached, the API server 101 may receive the call and may respond to the user terminal 110 with a success response (S204). Whether or not the API receives may be determined after incrementing the number of calls or may be determined before incrementing.

The number of calls received in a certain time period that holds the association may be calculated as time passes and updated, or, in a case where the call threshold is exceeded, a certain remaining time may be counted down and the number of calls may be reset when the certain remaining time reaches zero seconds. An example of the call threshold is a number of calls of 600 times within a certain time period of 60 seconds. Another example is a certain remaining time as 35 seconds.

Next, the API server 101 adds, to the first queue 102-1 connected to the API server 101, a first message transmission request including at least a portion of the assigned one or more message IDs and an identifier of a user of the user terminal 110 or a company they belong to. The added first message transmission request is received by the first control server 103 that periodically or intermittently accesses the first queue 102-1 to obtain data (S205).

The first message transmission request that the first control server 103 receives may include one or more destinations, one or more message IDs, one or more message bodies, and an identifier of a user or a company they belong to. In a case where the message body is not the same for each destination, a message body is prepared for each destination. In a case where a plurality of destinations are included, the same number of message IDs are included.

For example, the first message transmission request can be described as follows. In this example, the identifier of the user or the company they belong to is represented by operatorId, and the message body is the same for all destinations.

```
{
        “operatorId”: “OP9999999999”,
        “smsToList”:[
        {
        “messageId”:“msg-1111-2222”,
        “to”:“+819011111111”
        },
        {
        “messageId”:“msg-3333-4444”,
        “to”:“+819022222222”
        },
                (abbreviated)
        ],
        “payload”:“Your authentication code is 1234”,
        “callback”:“https://callback-domain/sms_result”,
        “encoding”:“ucs2”,
        “campaignId”:“cmpn-1111-2222”
        }
```

The first control server 103 updates a first association between the one or more identifiers and the number of first message transmission requests including each identifier received within a first predetermined time period by incrementing the number of requests for identifiers included in the received first message transmission request (S206).

In a case where the call received by the API server 101 does not include a campaign ID and includes a single destination, the API server 101 may assign a single message ID to the call and may add the first message transmission request including the single destination and the single message ID to the first one-off queue 102-2 for one-off messages distinct from the first queue 102-1 described above. By dividing the queue in this manner, a transmission request of a one-off message with a high possibility of having higher immediacy can be quickly sent to the first control server 103. The first control server 103 that receives the transmission request may add a second message transmission request including the single destination and the single message ID to the second one-off queue 104-2 selected in accordance with the single destination. The second control server 105 is connected to the second one-off queue 104-2 in addition to the second queue 104-1.

When the number of requests within the first predetermined time period is equal to or less than a first flow rate threshold (a positive number equal to or greater than 1), the first control server 103 adds, for each message ID, a second message transmission request to the second queue 104-1. When the number of requests is equal to or greater than the first flow rate threshold, the first control server 103 stops the processing of adding to the second queue until a first remaining time elapses. More generally, in a case where the number of requests within the first time period is compared with the first flow rate threshold and a first upper limit has not been reached, the first control server 103 generates the second message transmission request including each destination included in the first message transmission request received by the first control server 103 and adds them to the second queue 104-1. In a case where the first upper limit has been reached, the processing of adding the second message transmission request stops until the first remaining time has elapsed. In a case where the first message transmission request does not include a campaign ID, the first control server 103 that receives the first message transmission request may not perform the flow rate control described above and may add the second message transmission request of each message ID corresponding to the first message transmission request to the second one-off queue 104-2 without compromising immediacy.

The call received by the API server 101 or the first message transmission request received by the first control server 103 “not including a campaign ID” may include the campaign ID item being blank as well as an invalid number being set. This can more generally be substituted with “does not include a valid campaign designation”.

The first control server 103 may select the SMS gateway 120-1 to use according to the destination included in the second message transmission request to be added. Instead of the SMS gateway 120-1 being directly selected, the second queue 104-1 associated with the SMS gateway 120-1 or the second control server 105 may be selected. In a case where the second queue 104-1 or the second control server 105 associated therewith or the SMS gateway 120-1 is selected and used according to the destination in this manner, the first flow rate threshold may also be set to a value determined for the selected second queue 104-1 or the second control server 105 associated therewith or the SMS gateway 120-1 according to the selection. When a plurality of SMS gateways are used, the load is distributed. Thus, for each SMS gateway, it is preferable that the flow rate is controlled so that inequity among users is not great.

Each second message transmission request added to the second queue 104-1 or the second one-off queue 104-2 is received by the second control server 105 that periodically or intermittently accesses the second queue 104-1 or the second one-off queue 104-2 to obtain data (S207). The second message transmission request that the second control server 105 receives may include a single destination, a single message ID, a single message body, and an identifier of a user or a company they belong to.

For example, the second message transmission request can be described as follows.

{
“operatorId”: “OP9999999999”,
“messageId”:“msg-1111-2222”,
“to”:“+819011111111”
“payload”:“Your authentication code is 1234”,
“callback”:“ https://callback-domain/sms_result ”,
“encoding”:“ucs2”,
“campaignId”:“cmpn-1111-2222”
}

The number of requests received in the first predetermined time period that holds the first association may be calculated as time passes and updated, or, in a case where the first flow rate threshold is exceeded, a predetermined first remaining time may be counted down and the number of requests may be reset when the first remaining time reaches zero seconds. More generally, the first control server 103 can stop the processing of adding the second message transmission request until a first predetermined condition such as that described above is satisfied. An example of the first flow rate threshold is a number of requests of 600 times within the first predetermined time period of 30 seconds. Another example is the first remaining time as 20 seconds. Preferably, the first flow rate threshold is greater than the call threshold.

The second control server 105 updates the number of the second message transmission requests received within a second predetermined time period by incrementation (S208). When the number of requests within the second predetermined time period is equal to or less than a second flow rate threshold (a positive number equal to or greater than 1), the second control server 105 transmits an SMS message transmission request according to an IP protocol to the SMS gateway 120 (S209). When the number of requests is equal to or greater than the second flow rate threshold, the processing is stopped. More generally, in a case where the number of requests within the second predetermined time period is compared with the second flow rate threshold and a second upper limit has not been reached, the second control server 105 transmits an SMS transmission request according to an IP protocol to the SMS gateway 120 (S209). In a case where the second upper limit has been reached, the processing is stopped until a second remaining time has elapsed.

The number of requests received in the second predetermined time period stored in the second control server 105 may be calculated as time passes and updated, or, in a case where the second flow rate threshold is exceeded, a predetermined second remaining time may be counted down and the number of requests may be reset when the second remaining time reaches zero seconds. More generally, the second control server 105 can stop the processing of the SMS message transmission request until a second predetermined condition such as that described above is satisfied. An example of the second flow rate threshold is a number of requests of 30 times within the second predetermined time period of 1 second. Another example is the second remaining time as 1 second. The second flow rate threshold can be determined for the selected second queue 104-1 or the second control server 105 associated therewith or the SMS gateway 120-1. Preferably, the first flow rate threshold is less than the second flow rate threshold.

The second control server 105 may be able to transmit an SMS message transmission request to a plurality of SMS gateways and not an SMS gateway separately determined according to the destination included in the second message transmission request. In this case, the second control server 105 may hold a second association between one or more SMS gateway IDs and the number of the second message transmission requests including each SMS gateway ID received within the second predetermined time period, may store the flow rate for each SMS gateway, and may control the flow rate using the second flow rate threshold of each SMS gateway. In this case, preferably, the first flow rate threshold is less than the second flow rate threshold of each SMS gateway.

As described above, by performing flow rate control per user or company they belong to in the first control server 103, fairness for the amount of time required to transmit SMS messages can be achieved. In addition, performing flow rate control per SMS gateway can suppress the condition determined for each SMS gateway being exceeded and SMS transmission requests being transmitted.

Also, as described above, the processing handled the API server 101, the first control server 103, and the second control server 105 constituting the system 100 are separate and data exchanged between the servers is performed via the queues. However, data may be sent between the servers without necessarily using the queues, and a portion or all of the processing may be executed by the same server. In a case where the same server executes the plurality of processing, the processing described as sending data between the servers may correspond simply to the data being generated in the server and read out.

Note that in the embodiment described above, when “only” is not used, for example, in “on the basis of only”, “according to only”, and “in a case where only”, it should be understood that it is expected that additional information may be taken into account. Also, for example, it should be understood that “in a case where a, then b” does not necessarily mean “in a case where a, always b” or “after a, b follows” unless explicitly stated. Also, “each a constituting A” does not mean that A is necessarily constituted by a plurality of components and includes the component being singular.

Also, it should be said that, with a certain method, program, terminal, apparatus, server, or system (hereinafter referred to as a method and the like), even if there are aspects where operations different from the operations described in the present specification, the aspects of the present invention are directed at the same operations as the operations described in the present specification, and the existence of operations different from the operations described in the present specification does not make the method and the like outside of the scope of the aspects of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A method for transmitting an SMS message using API via an SMS gateway that communicates with an SMSC of an MNO, the method comprising:
receiving, by an API server, a first call of the API from a first user terminal;
assigning, by the API server, a message ID to each one or plurality of destinations determined by the first call;
adding, by the API server, to a first queue connected to the API server, a first message transmission request including at least a portion of assigned one or plurality of message IDs and a first identifier of a first user of the first user terminal or a first company they belong to; and
in a case where a number of first message transmission requests including the first identifier received within a first time period has not reached a first upper limit in comparison with a first flow rate threshold (a positive number equal to or greater than 1), adding, by a first control server connected to the first queue, to a second queue connected to the first control server, a second message transmission request including each one of the at least a portion included in the first message transmission request, and in a case where the first upper limit has been reached, ceasing, by the first control server, to add the second message transmission request to the second queue until a first predetermined condition is satisfied, wherein
a second control server connected to the second queue transmits, to the SMS gateway, an SMS message transmission request according to an IP protocol corresponding to the second message generation request.

2. The method according to claim 1, wherein
the call includes one or more message bodies.

3. The method according to claim 1, further comprising:
in a case where a number of calls of the API including a campaign ID determined by the first call received within a certain time period has not reached a call upper limit in comparison with a call threshold (a positive number equal to or greater than 1), adding, by the API server, the first message transmission request to the first queue; and
responding, by the API server, to the first user terminal with an error response in a case where the call upper limit has been reached.

4. The method according to claim 3, wherein
the first flow rate threshold is greater than the call threshold.

5. The method according to claim 1, wherein
in a case where a number of second message generation requests received within a second time period has not reached a second upper limit in comparison with a second flow rate threshold (a positive number equal to or greater than 1), the second control server transmits the SMS message transmission request to the SMS gateway.

6. The method according to claim 5, wherein
the second message transmission request includes a destination corresponding to a message ID included in the second message transmission request, and
the second queue is selected by the first control server according to a destination included in the second message transmission request.

7. The method according to claim 6, wherein
the first flow rate threshold is a value determined for the selected second queue, or the second control server or the SMS gateway associated therewith.

8. The method according to claim 1, further comprising:
receiving, by the API server, from a second user terminal, a second call of the API not including a valid campaign designation and including a single destination;
assigning, by the API server, a single message ID to the second call; and
adding, by the first control server, a second message transmission request including the single destination and the single message ID to a one-off queue connected to the second control server.

9. The method according to claim 6, wherein
the second flow rate threshold is a value determined for the selected second queue, or the second control server or the SMS gateway associated therewith.

10. The method according to claim 9, wherein
the first flow rate threshold is less than the second flow rate threshold.

11. A non-transitory computer readable storage medium storing a program for causing a system comprising an API server and a first control server to execute a method for transmitting an SMS message using API via an SMS gateway that communicates with an SMSC of an MNO, the method comprising:
receiving, by an API server, a first call of the API from a first user terminal;
assigning, by the API server, a message ID to each one or plurality of destinations determined by the first call;
adding, by the API server, to a first queue connected to the API server, a first message transmission request including at least a portion of assigned one or plurality of message IDs and a first identifier of a first user of the first user terminal or a first company they belong to; and
in a case where a number of first message transmission requests including the first identifier received within a first time period has not reached a first upper limit in comparison with a first flow rate threshold (a positive number equal to or greater than 1), adding, by a first control server connected to the first queue, to a second queue connected to the first control server, a second message transmission request including each one of the at least a portion included in the first message transmission request, and in a case where the first upper limit has been reached, ceasing, by the first control server, to add the second message transmission request to the second queue until a first predetermined condition is satisfied, wherein
a second control server connected to the second queue transmits, to the SMS gateway, an SMS message transmission request according to an IP protocol corresponding to the second message generation request.

12. A system comprising a first control server and an API server for transmitting an SMS message using API via an SMS gateway that communicates with an SMSC of an MNO, wherein
the API server
receives a first call of the API from a first user terminal,
assigns a message ID to each one or plurality of destinations determined by the first call,
adds, to a first queue connected to the API server, a first message transmission request including at least a portion of assigned one or plurality of message IDs and a first identifier of a first user of the first user terminal or a first company they belong to, and
the first control server connected to the first queue
in a case where a number of first message transmission requests including the first identifier received within a first time period has not reached a first upper limit in comparison with a first flow rate threshold (a positive number equal to or greater than 1), adds, to a second queue connected to the first control server, a second message transmission request including each one of the at least a portion included in the first message transmission request, and in a case where the first upper limit has been reached, ceases to add the second message transmission request to the second queue until a first predetermined condition is satisfied, wherein
a second control server connected to the second queue transmits, to the SMS gateway, an SMS message transmission request according to an IP protocol corresponding to the second message generation request.
